(19) United States
(12) Patent Application Publication
(10) Pub. No.: US 2026/0021540 A1
(43) Pub. Date: Jan. 22, 2026

(54) WAFER PRODUCTION METHOD

(71) Applicant: DISCO CORPORATION, Tokyo (JP)

(72) Inventor: Satoshi GENDA, Tokyo (JP)

(21) Appl. No.: 19/257,677

(22) Filed: Jul. 2, 2025

(30) Foreign Application Priority Data
Jul. 16, 2024 (JP) 2024-113266

(51) Int. Cl. B23K 26/53; B23K 26/00; B23K 103/00

(52) U.S. Cl. CPC B23K 26/53; B23K 26/0006; B23K 2103/56

(57) ABSTRACT

A wafer production method for producing a wafer from a workpiece having a first surface and a second surface that is in an opposite side of the first surface. The wafer production method includes: forming a separation start point including a modified region and a crack extending from the modified region by setting a focal point of a laser beam having a transmission wavelength at a position deeper than the first surface of the workpiece and applying the laser beam to the workpiece from the first surface; and separating, as the wafer, a plate-shaped object including the first surface of the workpiece from the separation start point by applying an ultrasonic wave to the first surface of the workpiece. The workpiece in the separating has a substrate attached to the second surface.

### CROSS-REFERENCE TO RELATED APPLICATIONS

This application is based on and claims priority under 35 USC 119 from Japanese Patent Application No. 2024-113266 filed on Jul. 16, 2024, the contents of which are incorporated herein by reference.

### TECHNICAL FIELD

The present disclosure relates to a wafer production method.

### BACKGROUND

As a method for producing a wafer of a semiconductor or so on, Japanese Patent Application Laid-Open Publication No. 2016-111143 describes a method in which a laser beam having a transmission wavelength is focused and applied to a hexagonal single crystal ingot from a front surface side thereof to form a separation start point including a modified layer and a crack extending from the modified layer inside the ingot, and then a plate-shaped object is separated from the ingot to produce a wafer.

Japanese Patent Application Laid-Open Publication No. 2016-146446 describes a method in which a wafer is produced by immersing a hexagonal single crystal ingot, in which a separation start point is formed, in water and applying ultrasonic waves to the ingot to separate a plate-shaped object from the ingot.

In Japanese Patent Application Laid-Open Publication No. 2016-146446, as the ingot becomes thinner, it becomes more difficult to separate the wafer from the ingot by ultrasonic waves, which causes a problem of reduced wafer production efficiency.

The present disclosure provides a wafer production method in which a wafer can be successfully separated from a workpiece by ultrasonic waves even when the workpiece is thin.

### SUMMARY

An aspect of the present disclosure relates to a wafer production method for producing a wafer from a workpiece having a first surface and a second surface that is in an opposite side of the first surface. The wafer production method includes: forming a separation start point including a modified region and a crack extending from the modified region by setting a focal point of a laser beam having a transmission wavelength at a position deeper than the first surface of the workpiece and applying the laser beam to the workpiece from the first surface; and separating, as the wafer, a plate-shaped object including the first surface of the workpiece from the separation start point by applying an ultrasonic wave to the first surface of the workpiece. The workpiece in the separating has a substrate attached to the second surface.

### BRIEF DESCRIPTION OF DRAWINGS

Exemplary embodiment(s) of the present disclosure will be described in detail based on the following figures, wherein

FIG. 1 is a perspective view illustrating a laser processing apparatus 1;

FIG. 2 illustrates a laser beam applying mechanism 8 of the laser processing apparatus 1;

FIG. 3 is a diagram illustrating a state in which a laser beam is applied from a front surface 11a of an ingot 11 by a focusing means 84;

FIG. 4 is a diagram illustrating a laser beam applying mechanism 8 according to a modification;

FIG. 5 is a schematic side view of a separation apparatus 9, illustrating a state in which ultrasonic waves are applied to the ingot 11 by an ultrasonic oscillation unit 91;

FIG. 6 is a schematic side view of the separation apparatus 9, illustrating a state in which a wafer W is separated from the ingot 11 by a separation unit 96;

FIG. 7 is a flowchart of one embodiment of a wafer production method; and

FIG. 8 illustrates a modification of the separation apparatus 9.

### DESCRIPTION OF EMBODIMENTS

Hereinafter, an embodiment of a wafer production method of the present disclosure will be described with reference to the accompanying drawings.

First, a laser processing apparatus 1 and a separation apparatus 9 used in the wafer production method will be described.

### Laser Processing Apparatus

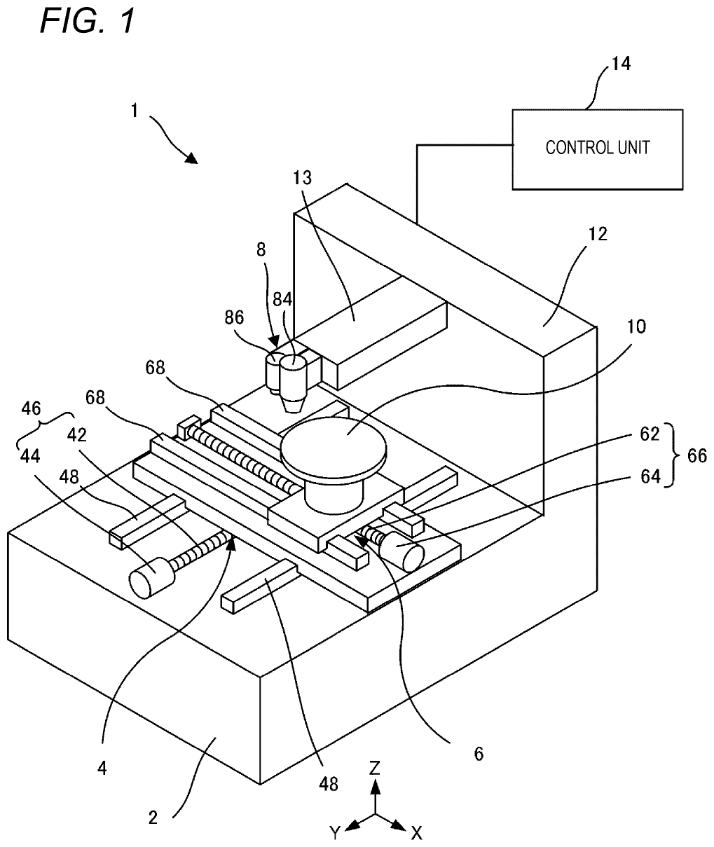

FIG. 1 is a perspective view illustrating the laser processing apparatus 1. In the following description, an X-axis direction is one direction on a horizontal plane. AY-axis direction is a direction orthogonal to the X-axis direction on the horizontal plane. A Z-axis direction is a direction orthogonal to the X-axis direction and the Y-axis direction.

The laser processing apparatus 1 of the present embodiment includes a base 2, a first slide block 4 mounted on the base 2 so as to be movable in the Y-axis direction, a second slide block 6 mounted above the first slide block 4 and movable in the X-axis direction, a holding table 10 provided on the second slide block 6, a column 12 erected on the base 2, a laser beam applying mechanism 8 attached to the column 12, and a control unit 14 that controls the laser processing apparatus 1.

The first slide block 4 is movable in an indexing direction, that is, in the Y-axis direction along a pair of guide rails 48 by an indexing mechanism 46 including a ball screw 42 and a pulse motor 44.

The second slide block 6 is mounted above the first slide block 4 so as to be movable in the X-axis direction.

That is, the second slide block 6 is movable in a feeding direction, that is, the X-axis direction along a pair of guide rails 68 by a feeding mechanism 66 including a ball screw 62 and a pulse motor 64.

The holding table 10 is mounted on the second slide block 6. The holding table 10 is movable in the X-axis direction and the Y-axis direction by the feeding mechanism 66 and the indexing mechanism 46, and is rotatable by a motor accommodated in the second slide block 6.

The column 12 is erected on the base 2, and the laser beam applying mechanism 8 is attached to the column 12.

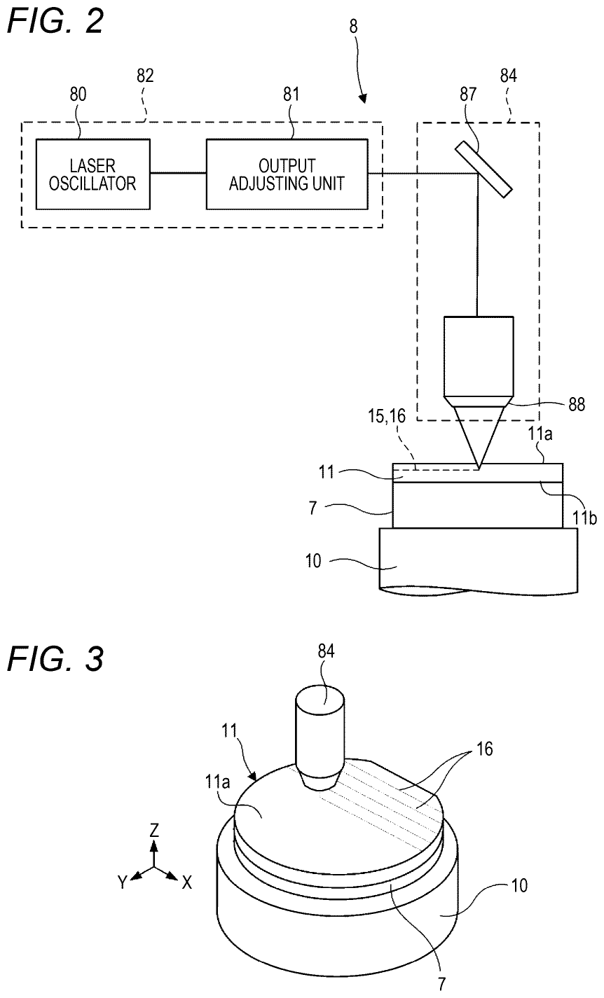

FIG. 2 is a diagram illustrating the laser beam applying mechanism 8 of the laser processing apparatus 1. As shown in FIGS. 1 and 2, the laser beam applying mechanism 8 includes a laser beam generating unit 82 accommodated in a casing 13 and a focusing means (laser head) 84 attached to a tip end of the casing 13. An imaging unit 86 having a microscope and a camera is attached to the tip end of the casing 13 adjacent to the focusing means 84.

The laser beam generating unit 82 includes a laser oscillator 80 that oscillates a YAG laser or a YVO4 laser, and an output adjusting unit 81. Although not particularly illustrated, the laser oscillator 80 has a Brewster window, and the laser beam emitted from the laser oscillator 80 is a linearly polarized laser beam.

The pulsed laser beam adjusted to a predetermined power by the output adjusting unit 81 of the laser beam generating unit 82 is reflected by a mirror 87 of the focusing means 84, and is applied by a focusing lens 88 at a focal point positioned inside an ingot 11, which is an example of a workpiece fixed to the holding table 10.

The material of the ingot 11 is not particularly limited, and is, for example, a SiC single crystal ingot or a GaN single crystal ingot. The ingot 11 is not limited to a single crystal ingot and may be a polycrystalline ingot. The ingot 11 has a front surface 11a and a back surface 11b that is in an opposite side of the front surface 11a (namely). The front surface 11a of the ingot 11 is polished into a mirror surface because the laser beam is applied to the front surface 11a. The ingot 11 has a thickness of, for example, 0.35 mm to 100 mm. Although details will be described later, in the present embodiment, a substrate 7 is attached to the back surface 11b of the ingot 11.

The control unit 14 controls each of the components of the laser processing apparatus 1 described above to cause the laser processing apparatus 1 to perform various processes on a workpiece. The control unit 14 is a computer including a control part that performs various calculations, a storage unit having a storage medium, and an input and output interface (not illustrated) that controls input and output of data between the inside and outside of the control unit 14. The control part includes, for example, a microprocessor such as a central processing unit (CPU). The storage unit includes a memory such as a hard disk drive (HDD), a read only memory (ROM), or a random access memory (RAM). The control part performs various calculations based on a predetermined program stored in the storage unit. The control part outputs, according to a calculation result, various control signals to the components described above via the input and output interface, and controls the laser processing apparatus 1.

FIG. 3 is a diagram illustrating a state in which a laser beam is applied from the front surface 11a of the ingot 11 by the focusing means 84. As illustrated in FIGS. 2 and 3, the laser processing apparatus 1 forms a separation start point 15 including a plurality of modified regions 16 inside the ingot 11.

Specifically, the laser processing apparatus 1 sets a focal point of a laser beam having a wavelength (for example, a wavelength of 1064 nm) that transmits through the ingot 11 held by the holding table 10 at a position deeper than the front surface 11a of the ingot 11, and forms the modified regions 16 by focusing and applying the laser beam from the front surface 11a of the ingot 11. Then, the laser processing apparatus 1 repeats a process of feeding the ingot 11 such that the focal point moves from one end to the other end of the ingot 11 along the X-axis direction to form the modified regions 16 along the X-axis direction, subsequently moving the ingot 11 by a predetermined amount in the Y-axis direction, and then feeding the ingot 11 such that the focal point moves from the other end to the one end of the ingot 11 along the X-axis direction to form the modified regions 16 along the X-axis direction. Accordingly, the separation start point 15 including the modified regions 16 and cracks (not illustrated) extending from the modified regions 16 is formed inside the ingot 11.

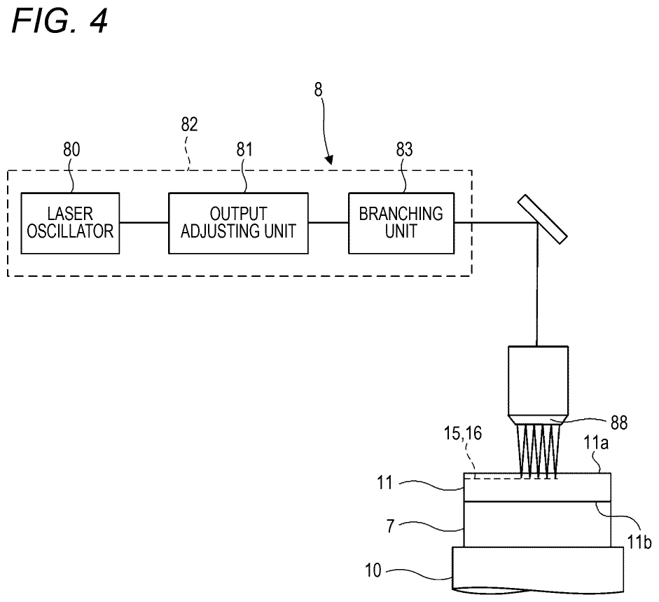

The laser beam applying mechanism 8 of the laser processing apparatus 1 is not limited to the configuration described above. FIG. 4 is a diagram illustrating a laser beam applying mechanism 8 according to a modification. In the laser beam applying mechanism 8 according to the modification, the laser beam generating unit 82 further includes a branching unit 83 in addition to the laser oscillator 80 and the output adjusting unit 81. The branching unit 83 branches a laser beam, the output of which is adjusted by the output adjusting unit 81, into a plurality of laser beams (for example, five laser beams) at predetermined intervals in a predetermined direction in an XY plane. For example, by branching a laser beam into a plurality of laser beams in the Y-axis direction in the XY plane, a plurality of modified regions 16 can be formed along the X-axis direction in a single feed.

### Separation Apparatus

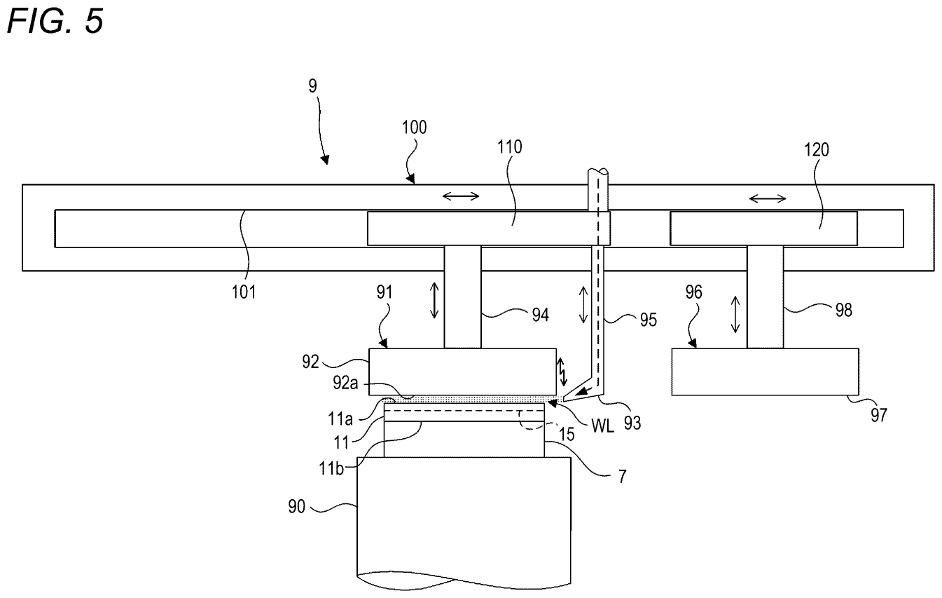

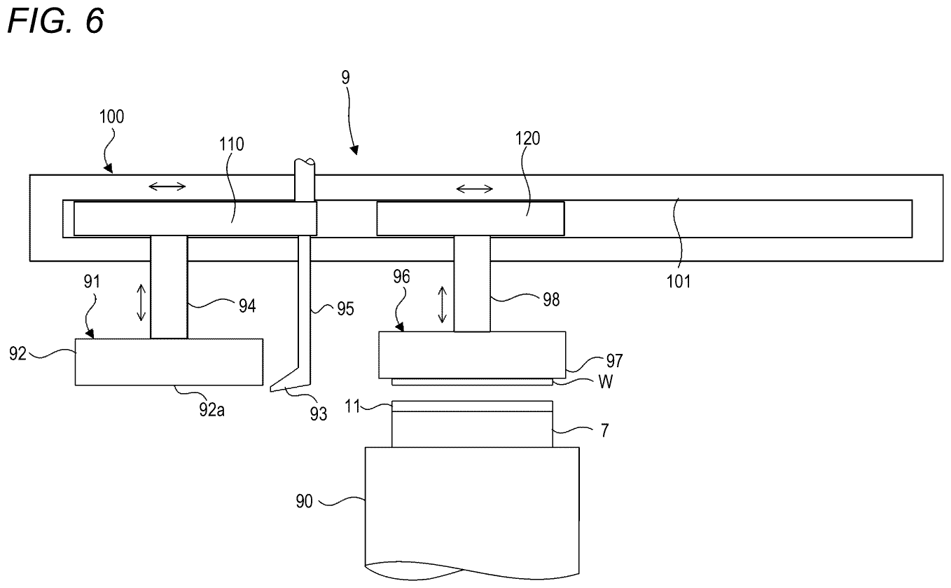

FIGS. 5 and 6 are schematic side views of the separation apparatus 9. FIG. 5 is a diagram illustrating a state in which ultrasonic waves are applied to the ingot 11, and FIG. 6 is a diagram illustrating a state in which a wafer W is separated from the ingot 11.

The separation apparatus 9 includes a cylindrical holding table 90 that holds the ingot 11 with the front surface 11a of the ingot 11 facing upward, an ultrasonic oscillation unit 91 that applies ultrasonic waves to the ingot 11, a separation unit 96 that separates the wafer W (see FIG. 6) from the ingot 11, and a moving mechanism 100 that moves the ultrasonic oscillation unit 91 and the separation unit 96 in a horizontal direction.

For example, the holding table 90 holds the ingot 11 via an epoxy resin-based adhesive, or holds the ingot 11 under suction by a suction force generated by a suction source (not illustrated). The holding table 90 is rotatable about an axis that passes through a radial center and extends in a vertical direction.

A rectangular opening 101 extending in the horizontal direction is formed in the moving mechanism 100, and a moving piece 110 supporting the ultrasonic oscillation unit 91 and a moving piece 120 supporting the separation unit 96 are movable along the opening 101. Although not illustrated, the moving mechanism 100 includes a ball screw coupled to the moving pieces 110 and 120, a motor that rotates the ball screw, and the like.

As illustrated in FIG. 5, the ultrasonic oscillation unit 91 includes an ultrasonic transducer 92 that has an end surface 92a facing the front surface 11a of the ingot 11 held by the holding table 90 and applies ultrasonic waves to the ingot 11, a liquid supply nozzle 93 that supplies a liquid (for example, pure water) between the front surface 11a of the ingot 11 and the end surface 92a of the ultrasonic transducer 92, a transducer lifting mechanism 94 that extends downward from a lower surface of the moving piece 110 and adjusts a vertical position of the ultrasonic transducer 92, and a nozzle lifting mechanism 95 that extends downward from the lower surface of the moving piece 110 and adjusts a vertical position of the liquid supply nozzle 93. The transducer lifting mechanism 94 and the nozzle lifting mechanism 95 are implemented by air cylinders, ball screws, motors, and the like. The dashed arrows in FIG. 5 indicate the flow of the liquid ejected from the liquid supply nozzle 93.

The ultrasonic transducer 92 is positioned at a position where a slight gap (for example, 0.6 mm) is provided between the end surface 92a and the front surface 11a of the ingot 11 by the transducer lifting mechanism 94. The ultrasonic waves applied to the ingot 11 have, for example, a frequency of 20 kHz to 50 kHz.

While the ultrasonic waves are being applied to the ingot 11, the liquid supply nozzle 93 continuously supplies the liquid to the gap between the end surface 92a of the ultrasonic transducer 92 and the front surface 11a of the ingot 11 to form a liquid layer WL. The ultrasonic waves emitted from the ultrasonic transducer 92 are transmitted to the ingot 11 via the liquid layer WL to extend the cracks at the separation start point 15 formed in the ingot 11. Accordingly, the strength of the separation start point 15 decreases.

The separation unit 96 includes a suction pad 97 that holds under suction the wafer W to be separated from the ingot 11, and a pad lifting mechanism 98 that extends downward from a lower surface of the moving piece 120 and adjusts a vertical position of the suction pad 97. The pad lifting mechanism 98 are implemented by an air cylinder, a ball screw, a motor, and the like.

As illustrated in FIG. 6, after the ultrasonic waves are applied to the entire front surface 11a of the ingot 11, the moving pieces 110 and 120 move, and the suction pad 97 moves to a position facing the ingot 11 held on the holding table 90. Then, the separation unit 96 causes the suction pad 97 to suction the front surface 11a of the ingot 11 and moves the suction pad 97 upward, thereby separating, as the wafer W, a plate-shaped object including the front surface 11a of the ingot 11 from the separation start point 15 of the ingot 11.

### Wafer Production Method

Next, an embodiment of a wafer production method of the present disclosure will be described.

The processing by the laser processing apparatus 1 and the separation apparatus 9 described above is repeatedly performed on the ingot 11, and a plurality of wafers W are produced from one ingot 11. For example, a plurality of wafers W having a thickness of 0.4 mm are produced from an ingot 11 having a thickness of 40 mm.

When the processing by the laser processing apparatus 1 and the separation apparatus 9 is repeatedly performed on one ingot 11 and the ingot 11 becomes thinner, it becomes more difficult to separate the wafer W from the ingot 11 even if ultrasonic waves are applied by the ultrasonic oscillation unit 91 of the separation apparatus 9. Specifically, when ultrasonic waves are applied to an ingot 11 having a certain thickness, an upper portion and a lower portion of the ingot 11 with respect to the separation start point 15 vibrate with phases shifted from each other, promoting the extension of cracks at the separation start point 15 formed in the ingot 11. On the other hand, when ultrasonic waves are applied to the ingot 11 in a state where the ingot 11 becomes thinner (for example, the thickness of the ingot 11 is about 5 mm), a weight difference between the upper portion and the lower portion of the ingot 11 with respect to the separation start point 15 becomes smaller, the phase shift therebetween during vibration becomes smaller, and thus the upper portion and the lower portion vibrate integrally. Accordingly, the cracks at the separation start point 15 formed in the ingot 11 are less likely to extend, and as a result, it becomes more difficult to separate the wafer W from the ingot 11.

Therefore, in the method for producing the wafer W of the present embodiment, the substrate 7 is attached to the back surface 11b of the ingot 11, and ultrasonic waves are applied from the front surface 11a to the ingot 11 to which the substrate 7 is attached.

The substrate 7 is a member that is sufficiently heavier than the wafer W to be produced, and is attached to the back surface 11b of the ingot 11 via, for example, an epoxy resin-based adhesive, a tape, or the like. The substrate 7 is formed in a plate shape and has a thickness of, for example, 5 mm or more, but the thickness can be freely set and may be less than 5 mm. The substrate 7 is made of glass, silicon, resin, ceramics, or the like, and may be made of the same material as the ingot 11. In the example illustrated in FIG. 5, the substrate 7 has the same diameter as the ingot 11, but may have a smaller or larger diameter than the ingot.

Since the substrate 7 is attached to the back surface 11b of the ingot 11 in this manner, a sufficient weight is imparted to the ingot 11 even if the ingot 11 becomes thinner. Therefore, when ultrasonic waves are applied to the ingot 11, a sufficient weight difference occurs between the upper portion and the lower portion of the ingot 11 with respect to the separation start point 15, and the upper portion and the lower portion vibrate with phases shifted from each other, promoting the extension of cracks at the separation start point 15 formed in the ingot 11. Therefore, even when the ingot 11 becomes thinner, the wafer W can be successfully separated from the ingot 11, and as a result, the production efficiency of the wafer W can be improved.

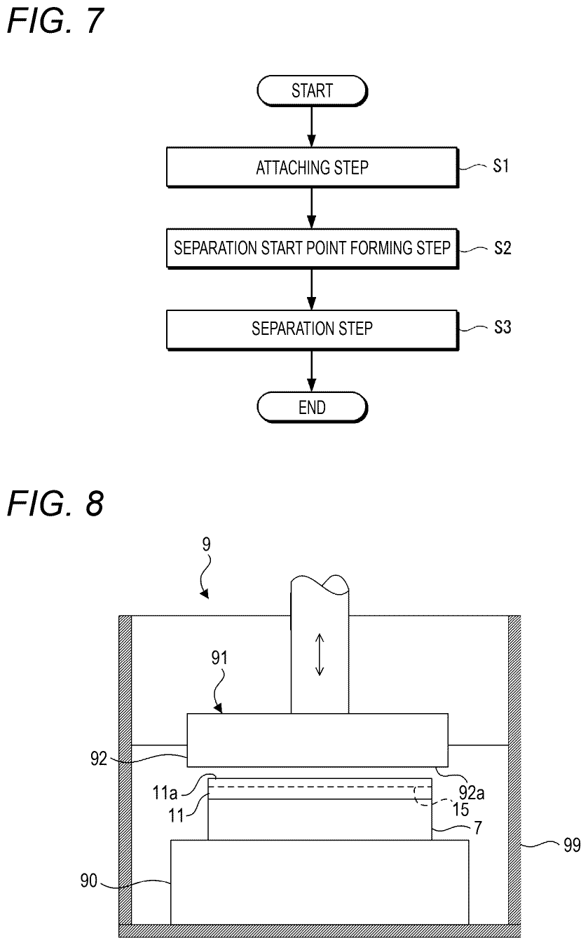

FIG. 7 is a flowchart of an embodiment of the wafer production method. The wafer production method includes an attaching step S1 of attaching the substrate 7 to the back surface 11b of the ingot 11, a separation start point forming step S2 of forming the separation start point 15 in the ingot 11 by the laser processing apparatus 1, and a separation step S3 of separating the wafer W from the separation start point 15 of the ingot 11 by the separation apparatus 9.

As described above, in the separation start point forming step S2, by applying a laser beam to the ingot 11 from the front surface 11a of the ingot 11 with a focal point of the laser beam set at a position deeper than the front surface 11a, the separation start point 15 including modified regions 16 and cracks extending from the modified regions 16 is formed. In the separation step S3, by applying ultrasonic waves to the front surface 11a of the ingot 11, a plate-shaped object including the front surface 11a of the ingot 11 is separated, as the wafer W, from the separation start point 15. The separation start point forming step S2 and the separation step S3 are repeatedly performed to produce a plurality of wafers W from the ingot 11.

The attaching step S1 is preferably performed, for example, before the separation start point forming step S2 which is performed first among the separation start point forming step S2 and the separation step S3 which are repeatedly performed. By attaching the substrate 7 to the ingot 11 from the beginning, the work efficiency can be improved as compared with a case where the substrate 7 is attached to the ingot 11 when the ingot 11 becomes thinner. The attaching step S1 may be performed when the ingot 11 becomes thinner.

### Modification

FIG. 8 illustrates a modification of the separation apparatus 9. The separation apparatus 9 of the modification includes a water tank 99 that stores a liquid, and the ultrasonic transducer 92, the ingot 11, and the substrate 7 are disposed in the liquid. That is, ultrasonic waves emitted from the ultrasonic transducer 92 are applied to the ingot via the liquid stored in the water tank 99. With such a configuration, it is also possible to promote the extension of cracks at the separation start point 15 formed in the ingot 11.

Although the embodiment of the present disclosure has been described above with reference to the accompanying drawings, it is needless to say that the present disclosure is not limited to the embodiment. It is obvious that those skilled in the art may come up with various changes or modifications within the scope of the claims, and it is understood that these naturally fall within the technical scope of the present disclosure. In addition, components in the embodiment described above may be freely combined without departing from the gist of the disclosure.

For example, the wafer production method of the embodiment described above has been described by taking the case where the workpiece is the ingot 11 as an example, but the present disclosure is not limited thereto, and the workpiece may be the wafer W, for example. That is, one wafer W may be further divided into a plurality of wafers by performing the wafer production method of the embodiment described above on one wafer W. In this case, since the substrate 7 is attached to the wafer W in the separation step S3, a sufficient weight is imparted to the wafer W which is a thin plate-shaped object, and a plurality of wafers can be successfully separated from the wafer W.

The present specification describes at least the following matters. Corresponding components and the like in the embodiment described above are shown in parentheses as an example, but the present disclosure is not limited thereto.
(1) A wafer production method for producing a wafer (wafer W) from a workpiece (ingot 11, wafer W) having a first surface (front surface 11a) and a second surface (back surface 11b) facing the first surface, the wafer production method including:
forming (separation start point forming step S2) a separation start point (separation start point 15) including a modified region (modified region 16) and a crack extending from the modified region by setting a focal point of a laser beam having a transmission wavelength at a position deeper than the first surface of the workpiece and applying the laser beam to the workpiece from the first surface; and
separating (separation step S3), as the wafer, a plate-shaped object including the first surface of the workpiece from the separation start point by applying an ultrasonic wave to the first surface of the workpiece, in which
the workpiece in the separating has a substrate (substrate 7) attached to the second surface.

According to (1), in the separating, since the workpiece has a substrate attached to the second surface, a sufficient weight is imparted to the workpiece when the workpiece becomes thinner or when the workpiece is thin, and the wafer can be successfully separated from the workpiece.
(2) The wafer production method according to (1), in which
the substrate is attached to the second surface of the workpiece before the forming which is performed first among the forming and the separating which are repeatedly performed on the workpiece.

According to (2), by attaching the substrate to the workpiece from the beginning, the work efficiency can be improved as compared with a case where the substrate is attached when the workpiece becomes thinner.

1. A wafer production method for producing a wafer from a workpiece having a first surface and a second surface that is in an opposite side of the first surface, the wafer production method comprising:
forming a separation start point including a modified region and a crack extending from the modified region by setting a focal point of a laser beam having a transmission wavelength at a position deeper than the first surface of the workpiece and applying the laser beam to the workpiece from the first surface; and
separating, as the wafer, a plate-shaped object including the first surface of the workpiece from the separation start point by applying an ultrasonic wave to the first surface of the workpiece, wherein
the workpiece in the separating has a substrate attached to the second surface.

2. The wafer production method according to claim 1, wherein
the substrate is attached to the second surface of the workpiece before the separating which is performed first among the forming and the separating which are repeatedly performed on the workpiece.
